(19) United States
(12) Patent Application Publication
(10) Pub. No.: US 2019/0082064 A1
(43) Pub. Date: Mar. 14, 2019

(54) IMAGE FORMING APPARATUS AND CONTROL METHOD FOR CREATING IMAGE INFORMATION

(71) Applicants: KABUSHIKI KAISHA TOSHIBA, Tokyo (JP); TOSHIBA TEC KABUSHIKI KAISHA, Tokyo (JP)

(72) Inventor: Keiko Kanamori, Numazu Shizuoka (JP)

(21) Appl. No.: 15/704,173

(22) Filed: Sep. 14, 2017

(51) Int. Cl. H04N 1/00; G06F 3/12; G06K 9/00; H04N 1/10

(52) U.S. Cl. CPC H04N 1/00474; G06F 3/1203; H04N 1/10; G06K 9/00288; H04N 1/00135; G06F 3/1253

(57) ABSTRACT

An image forming apparatus according to an embodiment includes an authentication unit, an acquisition unit, an image capturing unit, and a creation unit. The authentication unit authenticates a user. The acquisition unit acquires user information of the user whose authentication is successful from a server that manages the user information using the authentication unit. The image capturing unit captures an image of the user. The creation unit creates image information in which the image of the user obtained by capturing an image using the image capturing unit and the user information acquired by the acquisition unit are represented on a card.

### FIELD

Embodiments described herein relate generally to an image forming apparatus and a control method.

### BACKGROUND

When business cards or cards for some specific purpose are necessary, an order for them is usually placed with a printing company. In such an order is made, printing volume often needs in units of 100 sheets.

As needs for on-demand printing grow, the more cards are printed in-house. If the printing volume for them is small, information to be printed on the card and cards are prepared, and the cards are printed by a printer, multifunction peripheral (MFP), or the like. Here, the information to be printed on the card includes a full name, an address, a telephone number, a mail address, a company name, a department name, and the like.

However, in this method, it is troublesome to perform setting such that the information to be printed on the card is printed in accordance with a predetermined format. In addition, in the method, it is necessary to prepare a new department name immediately after the department name is changed. In addition, in the method, if a photograph needs to be printed on a card, the photograph has to be prepared. Therefore, in the method, printing work of the card performed by a user is complicated.

### DESCRIPTION OF THE DRAWINGS

FIG. 1 is an external view illustrating an example of the entire configuration of an image forming apparatus according to an embodiment.

FIG. 2 is a functional block diagram illustrating an example of a functional configuration of the image forming apparatus.

FIG. 3 is a view illustrating an example of a control panel of the image forming apparatus.

FIG. 4 is a view illustrating an example of a home screen of the image forming apparatus.

FIG. 5 is a view illustrating an example of a business card layout.

FIG. 6 is a view illustrating an example (first example) of photograph edition processing.

FIG. 7 is a view illustrating another example (second example) of the photograph edition processing.

FIG. 8 is a view illustrating an example of business card print.

FIG. 9 is a diagram illustrating an example of a hardware configuration of a server.

FIG. 10 is a functional block diagram illustrating an example of a functional configuration of the server.

FIG. 11 is a flowchart illustrating an example of an operation of the image forming apparatus.

### DETAILED DESCRIPTION

An image forming apparatus according to an embodiment includes an authentication unit, an acquisition unit, an image capturing unit, and a creation unit. The authentication unit authenticates a user. The acquisition unit acquires user information of the user whose authentication is successful from a server that manages the user information using the authentication unit. The image capturing unit captures an image of the user. The creation unit creates image information in which the image of the user obtained by capturing an image using the image capturing unit and the user information acquired by the acquisition unit are represented on a card.

Hereinafter, an image forming apparatus according to the embodiment and a control method will be described with reference to the drawings.

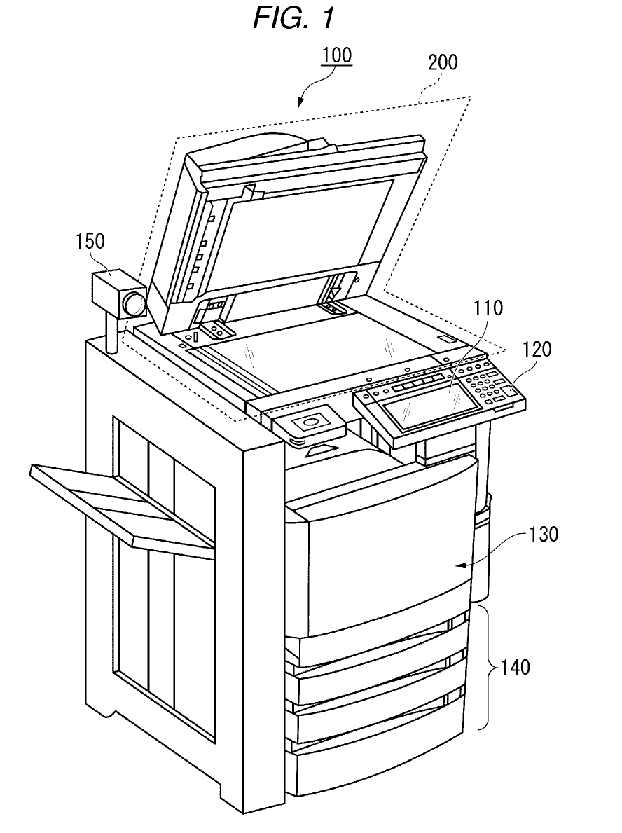

FIG. 1 is an external view illustrating an example of the entire configuration of the image forming apparatus according to the embodiment. The image forming apparatus 100 is an image forming apparatus such as a multifunction peripheral. The image forming apparatus 100 includes a display 110, a control panel 120, a printer unit 130, a sheet containing unit 140, an image reading unit 200, and an image capturing device 150. The printer unit 130 of the image forming apparatus 100 may be an apparatus for fixing a toner image or an ink jet type apparatus.

The image forming apparatus 100 reads an image displayed on a sheet, generates digital data, and generates an image file. The sheet is paper, an original document, or the like on which, for example, characters, images and the like are described. The sheet may be anything if the image forming apparatus 100 can read the sheet.

The display 110 is an image display device such as a liquid crystal display or an organic electro luminescence (EL) display. The display 110 displays various types of information relating to the image forming apparatus 100.

The control panel 120 includes a plurality of buttons. The control panel 120 receives an input of a user. The control panel 120 outputs a signal according to an operation performed by the user to an information processing unit of the image forming apparatus 100. The display 110 and the control panel 120 may be configured as an integral touch panel. Hereinafter, a case where the display 110 and the control panel 120 are configured as an integral touch panel will be described.

The printer unit 130 forms an image on a sheet, based on image information generated by the image reading unit 200 or image information received through a communication path. The printer unit 130 forms an image, for example, as follows. An image forming unit of the printer unit 130 forms an electrostatic latent image on a photoconductive drum, based on the image information. The image forming unit of the printer unit 130 forms a visible image by attaching a developer to the electrostatic latent image. A specific example of the developer is toner. A transfer unit of the printer unit 130 transfers the visible image onto the sheet. A fixing unit of the printer unit 130 fixes the visible image on the sheet by heating and pressurizing the sheet. The sheet on which the image is formed may be a sheet contained in the sheet containing unit 140 or may be a sheet manually fed.

The sheet containing unit 140 contains a sheet used for image formation in the printer unit 130.

The image reading unit 200 reads image information of a read target as light and darkness of light. The image reading unit 200 temporarily holds the read image information. The temporarily held image information may be formed an image on the sheet by the printer unit 130.

The image forming apparatus 100 according to the present embodiment reads a user ID or the like stored in an IC chip or the like built in a card held by a user and authenticates the user, based on the read user ID. The image forming apparatus 100 acquires user information of the user from a server that stores the user information, based on the user ID, if a user successfully authenticated selects an operation of printing a business card.

In addition, the image forming apparatus 100 acquires a business card layout stored in the server, and presents the acquired business card layout to the user. The image forming apparatus 100 starts the image capturing device 150 if the user selects a business card layout with a photograph in the presented business card layout and the user information does not include the user image information. By operating the started image capturing device 150, the user captures an image of the user himself or herself. The image forming apparatus 100 acquires image information obtained by capturing an image of the user himself or herself by the user.

The image forming apparatus 100 displays a print preview image in which the user information and the image of the user himself or herself are disposed in the business card layout selected by the user. If the user performs an operation of editing clothes or the like for the image of the user himself or herself, the image forming apparatus 100 edits the image of the user himself or herself. The image forming apparatus 100 changes the image of the user himself or herself to an edited image of the user himself or herself in the print preview image. If the user agrees with the print preview image, the image forming apparatus 100 creates image information of the print preview image, and stores the created image information. If the user performs an operation of printing the image information, the image forming apparatus 100 performs processing of the image information thereby printing the image information.

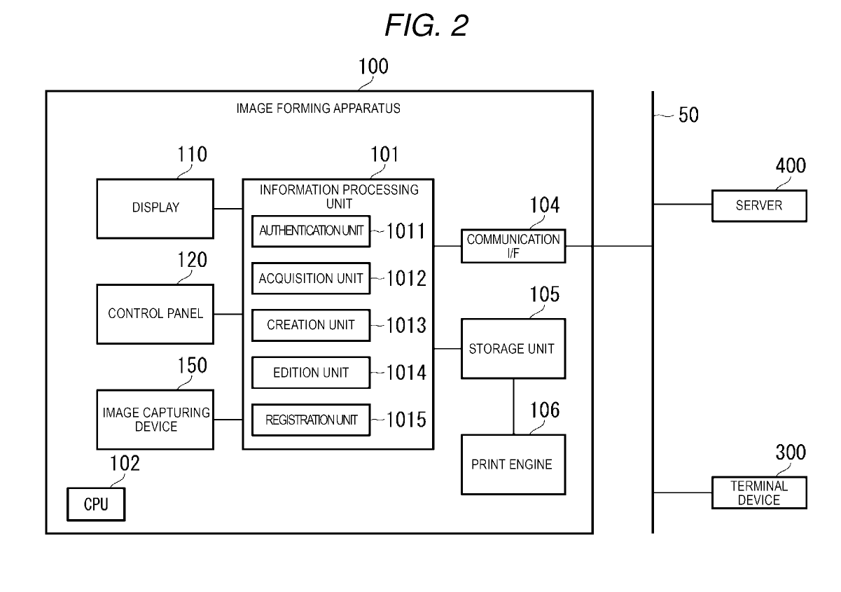

FIG. 2 is a functional block diagram illustrating a functional configuration of the image forming apparatus according to the embodiment.

The image forming apparatus 100 includes a central processing unit (CPU) 102, a memory, an auxiliary storage device, and the like which are connected to each other by a bus, and executes a control program. The image forming apparatus 100 functions as an apparatus including the display 110, the control panel 120, the image capturing device 150, an information processing unit 101, a communication I/F 104, a storage unit 105, and a print engine 106 by executing the control program.

All or a part of each function of the image forming apparatus 100 may be realized by using hardware such as an application specific integrated circuit (ASIC), a programmable logic device (PLD), a field programmable gate array (FPGA), or the like. The control program may be recorded on a computer readable recording medium. The computer-readable recording medium is a portable medium such as a flexible disk, a magneto-optical disk, a ROM or a CD-ROM, or a storage device such as a hard disk embedded in a computer system. The control program may be transmitted through an electric communication line.

The CPU 102 is an arithmetic device that realizes each function of the image forming apparatus 100 by reading a program and data stored in the storage unit 105 and the like into the RAM to execute.

The display 110 displays processing results and the like output from the information processing unit 101.

The control panel 120 is an input device operated by a user. For example, the control panel 120 is a display input device such as a touch panel display. In this case, the display 110 and the control panel 120 are integrated as one piece. Furthermore, if the user holds the card, the control panel 120 includes a receiver for reading a user ID stored in the IC chip or the like built in the card. The receiver outputs the read user ID to the information processing unit 101.

### Control Panel

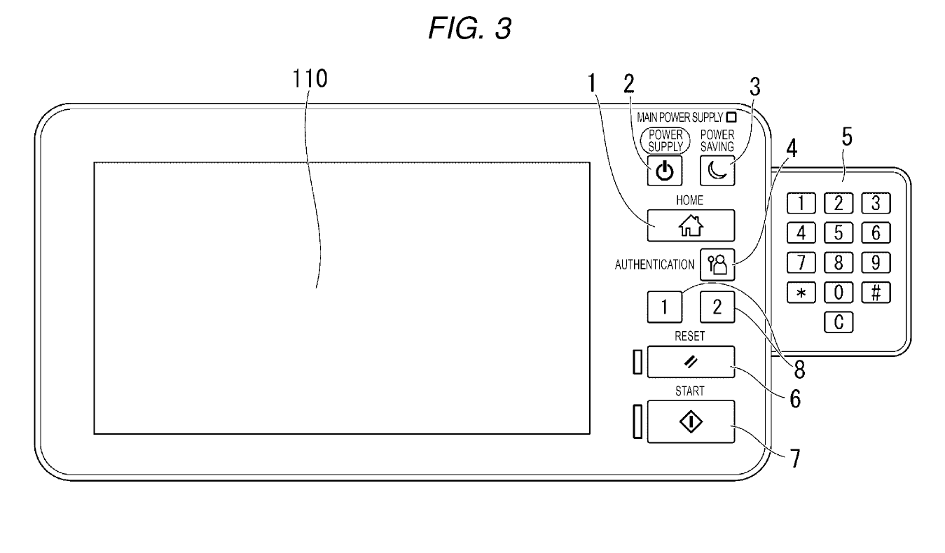

FIG. 3 is a view illustrating an example of the control panel. FIG. 3 also illustrates the display 110 in addition to the control panel 120. The control panel 120 includes a home button 1, a power button 2, a power saving button 3, an authentication button 4, ten keys 5, a reset button 6, a start button 7, and a function button 8.

The home button 1 is pressed when a home screen is displayed on the display 110. The power button 2 is pressed when a power supply of the image forming apparatus 100 is turned on or off. The power saving button 3 is pressed when the image forming apparatus 100 is changed from a normal mode into a power saving mode or is returned from the power saving mode to the normal mode.

The authentication button 4 is pressed when a user logs in to the image forming apparatus 100. As the user presses the authentication button 4, an authentication screen is displayed on the display 110. The authentication screen includes a box for inputting a user ID and a box for inputting a password. The user inputs a user ID into the box for inputting a user ID by using the ten keys 5 or the like which will be described below, and inputs a password into a box for inputting a password. The control panel 120 outputs a combination of the user ID and the password input by the user to the information processing unit 101. The information processing unit 101 authenticates the user, based on the combination of the user ID and the password output from the control panel 120 and outputs the authentication results to the control panel 120. The authentication results include the user ID.

In addition, logging in to the image forming apparatus 100 is also performed by reading the user ID stored in the IC chip or the like built in the card using the image forming apparatus 100, as the user touches a card to the image forming apparatus 100, in addition to a method of inputting a user ID and a password by pressing the above-described authentication button 4.

The ten keys 5 are pressed when numbers or the like are input. The reset button 6 is pressed when all the selected functions are cancelled and returned to initial setting. The start button 7 is pressed when an operation such as copying starts. The function button 8 is used to register frequently used functions. The function button 8 is pressed when the registered function is called up.

### Home Screen

A home screen will be described.

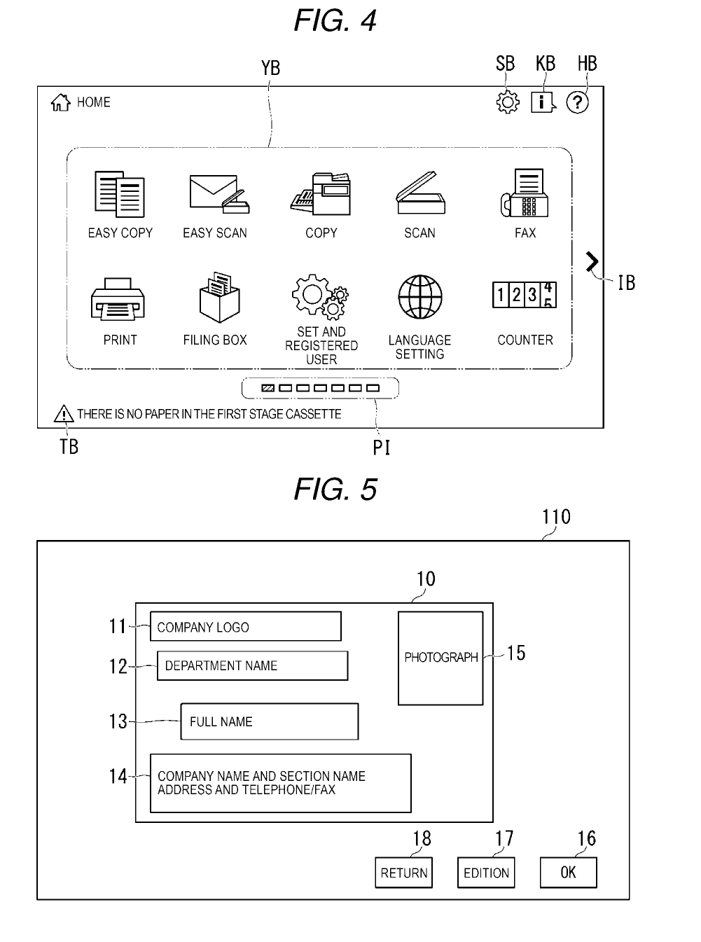

FIG. 4 is a view illustrating an example of the home screen. As described above, the home screen is displayed on the display 110.

A call button YB, a setting button SB, a situation confirmation button KB, a help button HB, a page movement button IB, a page position indicator PI, and a state notification button TB are displayed on the home screen.

The call button YB is pressed when a function, a template, a URL, and the like are registered and the function, the template, the URL, and the like which are registered are called. More specifically, the call button YB includes a plurality of icons, and the function, the template, the URL, and the like are registered in each of the plurality of icons. The function registered in the icon includes a business card print function. A user starts a function registered in the pressed icon in the image forming apparatus 100 by pressing any one of the plurality of icons. Hereinafter, a case where the user presses an icon (hereinafter, referred to as “a business card print icon”) in which the business card print function among the plurality of icons is registered will be continuously described.

If the authentication results output from the information processing unit 101 indicate that authentication is successful, the control panel 120 acquires the user ID of the user whose authentication is successful and makes it possible to select the business card print icon. If the authentication results output from the information processing unit 101 indicate that the authentication fails, the control panel 120 may display that the authentication fails. Here, a case where the authentication is successful will be continuously described.

If the user selects the business card print icon, the control panel 120 outputs information indicating business card print to the information processing unit 101. The information indicating the business card print includes the user ID.

The control panel 120 displays an image (hereinafter, referred to as “a business card type selection image”) for selecting a type of business card on the display 110. Here, the type of business card includes a single surface, double surfaces, a single surface with a photograph, double surfaces with photographs, and the like. The single surface indicates that printing is performed on a single surface. The double surfaces indicate that printing is performed on double surfaces, one surface is printed in Japanese, and the other surface is printed in English. The single surface with a photograph indicates that a photograph is printed on a single surface. The double surfaces with photographs indicate that photographs are printed on double surfaces, one surface is printed in Japanese and the other surface is printed in English. The information printed on one surface of the business card or the other surface may be company guide, a map, product introduction, and the like, and may be appropriately selected. Here, a case where the user selects the single surface with a photograph will be continuously described. In this case, a photograph and Japanese words are printed on a single surface. If the user presses the single surface with a photograph from the business card type selection image displayed on the display 110, the control panel 120 outputs business card type information including information indicating the single surface with a photograph to the information processing unit 101. The business card type information includes a user ID.

The control panel 120 displays an image (hereinafter, referred to as “a business card number selection image”) for selecting the number of business cards on the display 110. Here, a case where the user selects ten sheets will be continuously described. If the user selects the number of business cards from the business card number selection image displayed on the display 110, the control panel 120 outputs business card number information including information indicating the number of business cards to the information processing unit 101. The business card number information includes a user ID. Since the number of business cards can be designated, it is possible to cope with an operation of printing a small volume due to frequent movements. In addition, by designating the number of business cards, it is possible to cope with a case where several sheets may be required due to an instant movement, and a case where a user wants to replenish business cards because of no business card at hand while traveling to another department in the company.

The control panel 120 displays an image (hereinafter, referred to as “a business card format selection image”) for selecting a business card format on the display 110. Here, the business card format selection image displayed by the control panel 120 includes a business card format corresponding to the business card type information. Here, since the business card type information includes information indicating the single surface with a photograph, a business card format in which user information and a photograph are disposed on a single surface is displayed on the display 110. The control panel 120 outputs information indicating the business card format that a user selects from the business card format selection image displayed on the display 110 to the information processing unit 101. The information indicating the business card format includes a user ID.

The setting button SB is pressed when setting of the home screen is changed. The situation confirmation button KB is pressed when a progress state and execution history of a job are confirmed. The help button HB is pressed when a description for operating each function is displayed. The page movement button IB is pressed when a page is moved to a next page. The page position indicator PI displays a position of a current page. The state notification button TB is displayed when there is information to be notified by the image forming apparatus 100.

Description will be continued with reference to FIG. 2. The image capturing device 150 starts in accordance with a start instruction output from the information processing unit 101 which will be described below. The started image capturing device 150 captures an image of a user in accordance with an operation of the user. The image capturing device 150 generates image information by capturing an image, and outputs the generated image information to the information processing unit 101.

The information processing unit 101 is connected to the display 110, the control panel 120, and the image capturing device 150. All or a part of the information processing unit 101 is a functional unit (hereinafter, referred to as “a software functional unit”) realized by executing a program stored in the storage unit 105 using a processor such as a CPU. All or a part of the information processing unit 101 may be realized by hardware such as an LSI, an ASIC, an FPGA or the like, or may be realized by a combination of a software functional unit and hardware.

The information processing unit 101 includes, for example, an authentication unit 1011, an acquisition unit 1012, a creation unit 1013, an edition unit 1014, and a registration unit 1015.

The authentication unit 1011 performs processing of authenticating a user. More specifically, as the user touches a card to the image forming apparatus, the authentication unit 1011 determines whether or not a user ID output from the control panel 120 is included in a user ID, which is managed by the image forming apparatus 100, of a user who uses the image forming apparatus 100. If the user ID output from the control panel 120 is included in the user ID, which is stored in the storage unit 105, of the user who uses the image forming apparatus 100, the authentication unit 1011 determines that authentication is successful. If the user ID output from the control panel 120 is not included in the user ID, which is stored in the storage unit 105, of the user who uses the image forming apparatus 100, the authentication unit 1011 determines that the authentication fails.

In addition, the authentication unit 1011 determines whether or not a combination of the user ID and the password output from the control panel 120 in accordance with an input of a user is included in a combination of the user ID and the password stored in the storage unit 105. If the combination of the user ID and the password output from the control panel 120 is included in the combination of the user ID and the password stored in the storage unit 105, the authentication unit 1011 determines that authentication is successful. If the combination of the user ID and the password output from the control panel 120 is not included in the combination of the user ID and the password stored in the storage unit 105, the authentication unit 1011 determines that the authentication fails. The authentication unit 1011 outputs authentication results including information indicating that the authentication is successful or information indicating that the authentication fails to the control panel 120, the acquisition unit 1012, and the creation unit 1013. The authentication results include the user ID.

If the authentication results output from the authentication unit 1011 include information indicating that the authentication is successful, the acquisition unit 1012 acquires information indicating the business card print output from the control panel 120, the business card type information, and the business card number information. The acquisition unit 1012 creates a business card format acquisition request including business card type information and requesting acquisition of a business card format addressed to a server 400, and outputs the created business card format acquisition request to the communication I/F 104. The acquisition unit 1012 acquires a business card format acquisition response which is a response to the business card format acquisition request, through the communication I/F 104. The acquisition unit 1012 outputs the business card format included in the acquired business card format acquisition response to the control panel 120.

The control panel 120 displays the business card format output from the acquisition unit 1012 on the display 110. A user selects a business card format to be used from the business card format displayed on the display 110. As the user presses the business card format to be used on the display 110, information indicating the selected business card format is output to the information processing unit 101. The acquisition unit 1012 acquires the information indicating the business card format.

The acquisition unit 1012 outputs the information indicating the business card print, the business card type information, the business card number information, and the information indicating the business card format to the creation unit 1013. Furthermore, if the business card type information includes the information indicating presence of a photograph and the user information does not include the user image information, the acquisition unit 1012 outputs a start instruction to the image capturing device 150. The user captures an image of the user himself or herself by operating the started image capturing device 150. The image capturing device 150 acquires image information obtained as the user captures an image of the user himself or herself, and outputs the acquired image information to the information processing unit 101. The acquisition unit 1012 acquires the image information output from the image capturing device 150, and outputs the acquired image information to the creation unit 1013 and the registration unit 1015.

In addition, the acquisition unit 1012 acquires the user ID included in the authentication results. The acquisition unit 1012 creates information which includes the acquired user ID and requests to acquire user information corresponding to the user ID addressed to the server 400. Hereinafter, the information which requests to acquire the user information is referred to as a user information acquisition request. The acquisition unit 1012 outputs the created user information acquisition request to the communication I/F 104. In addition, the acquisition unit 1012 acquires a user information acquisition response that is a response to the user information acquisition request. The acquisition unit 1012 outputs the user information included in the acquired user information acquisition response to the creation unit 1013. The user information included in the user information acquisition response includes information relating to a user such as a company logo, a department name, a full name, a company name, a section name, an address, telephone/FAX, an e-mail address, and user image information.

The creation unit 1013 creates a preview image of a business card, based on the information indicating the business card print, the information indicating the business card format, the image information, and the user information which are output from the acquisition unit 1012. The creation unit 1013 displays the preview image of the created business card on the display 110.

FIG. 5 is a view illustrating an example of the business card layout. In the example illustrated in FIG. 5, a column 11 of the company logo, a column 12 of the department name, a column 13 of the full name, a column 14 of the company name, the section name, the address, and the telephone/FAX, and a column 15 of a photograph are disposed in a preview image 10 of a business card, based on the information indicating the business card format. The creation unit 1013 displays the company logo in the column 11 of the company logo. In addition, the creation unit 1013 displays the department name, the full name, and the company name and the section name and the address and the telephone/FAX which are included in the user information, in the column 12 of a department name, the column 13 of a full name, and the column 14 of the company name and the section name and the address and the telephone/FAX, respectively. The creation unit 1013 processes the image information to display the image of a user in the column 15 of a photograph. Furthermore, an OK button 16, an edition button 17, and a return button 18 are displayed on the display 110.

If a user agrees with the preview image 10 of a business card, the user presses the OK button 16. If the user presses the OK button 16, the creation unit 1013 outputs the information representing the preview image of a business card to the storage unit 105.

In addition, if the user does not agree with the preview image of print and the image information is edited, the user presses the edition button 17. If the user presses the edition button 17, the creation unit 1013 outputs information indicating edition and image information to the edition unit 1014. Here, a case where the user presses the edition button 17 will be described.

In addition, if the user does not agree with the preview image of print and an operation returns to a previous screen, the user presses the return button 18. If the user presses the return button 18, the control panel 120 displays the business card format selection image on the display 110.

The edition unit 1014 displays the image edition image on the display 110, based on the information indicating edition and the image information output from the creation unit 1013.

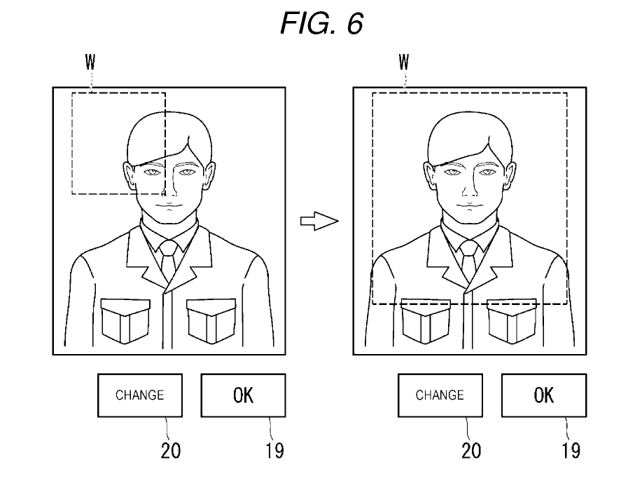

FIG. 6 is a view illustrating an example (first example) of photograph edition processing. The edition unit 1014 acquires the information indicating edition and the image information output from the creation unit 1013. The edition unit 1014 processes the image information to display an image of a user on the display 110. Furthermore, the edition unit 1014 displays an image for editing the image of a user on the display 110. In the example illustrated in FIG. 6, a rectangular frame W for designating a print region is displayed in the image of a user.

The user designates the print region by expanding the rectangular frame W displayed on the display 110 on the image of the user. Specifically, the user places his or her finger on a corner of the rectangular frame W and traces the display 110 as it is, thereby expanding the rectangular frame W and designating an upper body region of the image of the user. When designating the region is completed, and subsequently, if clothes are changed, the user presses the change button 20, and if the clothes are not changed, the user presses the OK button 19. As the user presses the change button 20, the edition unit 1014 determines the region designated by the rectangular frame W as a print region, and displays the image for changing the clothes. In addition, as the user presses the OK button 19, the edition unit 1014 determines the region designated by the rectangular frame W as the print region.

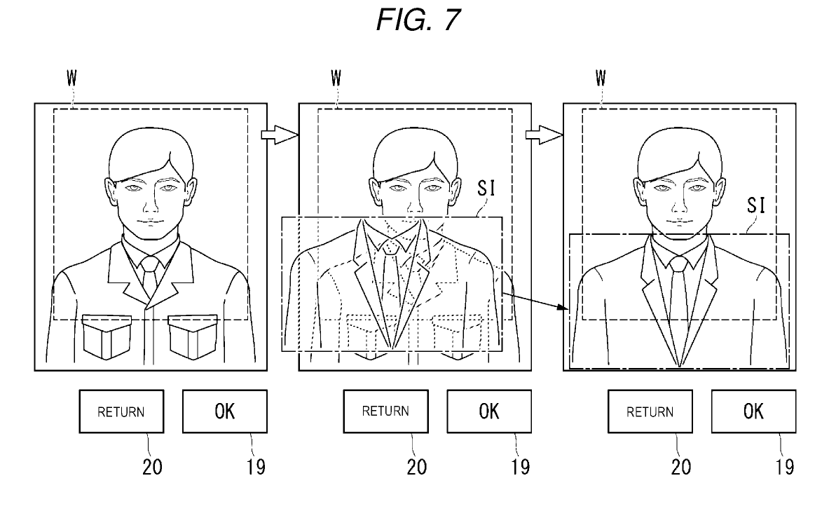

FIG. 7 is a view illustrating an example (second example) of the photograph edition processing. FIG. 7 illustrates processing of changing the clothes of a user from work clothes to a suit as an example of the photograph edition processing.

In FIG. 7, a left figure is an image of the user before edition processing is performed, and is an image after the upper body region of the image of the user is designated. An intermediate figure is an image of the user which is in the middle of edition processing, and a right figure is an image of the user after edition is completed. As the user presses the OK button 19 after the upper body region of the image of the user is designated, an image SI representing the suit is displayed as illustrated in the intermediate figure. Specifically, the edition unit 1014 overlaps the image of a user displayed on the display 110 before the edition processing is performed, and displays the image SI representing the suit. The image SI representing the suit is displayed in a semi-transparent manner.

The user adjusts a position of the image SI representing the suit so as to match the image of a user by tracing the display 110 while placing a finger of the user on the image SI representing the suit, and then presses the OK button 19. If the user presses the OK button 19, the edition unit 1014 returns the image SI representing the semi-transparent suit to a real image which is an image to be actually printed from a semi-transparent image.

The right figure of FIG. 7 is an image to be displayed if the user presses the OK button 19 after adjusting the position of the image SI representing the suit so as to match the image of the user. According to the right figure, the clothes of the user are changed from work clothes to a suit. If the user agrees with the image of the user, the user presses the OK button 19. If the user presses the OK button 19, the edition unit 1014 outputs information indicating the edited image of the user to the creation unit 1013. In addition, if the user does not agree with the image of the user, the user presses the return button 20. If the user presses the return button 20, the edition unit 1014 displays the rectangular frame W for designating the print region as illustrated in FIG. 6.

The creation unit 1013 processes the information indicating the edited image of the user output from the edition unit 1014, thereby, displaying the edited image of the user in the column 15 of the photograph. As a result, the display 110 displays the same image as an example of the preview image of a business card illustrated in FIG. 5. If the user agrees with the preview image of a business card, the user presses the OK button 19. If the user presses the OK button 19, the creation unit 1013 outputs information indicating the preview image of a business card to the storage unit 105.

The registration unit 1015 creates registration information including the information indicating the image of a user output from the acquisition unit 1012 and the user ID, and transmits the created registration information to the server 400.

The communication I/F 104 is connected to the information processing unit 101. The communication I/F 104 is realized by a communication module. The communication I/F 104 communicates with other devices such as a terminal device 300 and the server 400 via the network 50. The communication I/F 104 transmits the user information acquisition request output from the information processing unit 101 to the server 400. In addition, the communication I/F 104 receives the user information acquisition response transmitted from the server 400, and outputs the received user information acquisition response to the information processing unit 101.

In addition, the communication I/F 104 transmits the business card format acquisition request output from the information processing unit 101 to the server 400. In addition, the communication I/F 104 receives the business card format acquisition response transmitted from the server 400, and outputs the received business card format acquisition response to the information processing unit 101.

In addition, the communication I/F 104 transmits the registration information output from the information processing unit 101 to the server 400.

The storage unit 105 is configured by using a storage device such as a magnetic hard disk device or a semiconductor storage device. The storage unit 105 stores a program executed by the CPU 102 of the image forming apparatus 100. In addition, the storage unit 105 stores a user ID that allows use of the image forming apparatus 100, information that associates the user ID that allows the use of the image forming apparatus 100 with a password, and information indicating the preview image of a business card.

In addition, the image forming apparatus 100 is connected to the terminal device 300 through a LAN 50. The terminal device 300 may acquire and display the information indicating the preview image of a business card stored in the storage unit 105 of the image forming apparatus 100.

The print engine 106 acquires the information indicating the preview image of a business card stored in the storage unit 105, based on a print job. The print engine 106 processes the information indicating the acquired preview image of a business card, thereby, printing image data in which the business card information displayed in the preview image of a business card is laid out by the designated number of pages. Specifically, since the user selects printing 10 business cards, the print engine 106 prints image data in which 10 pieces of business card information displayed in the preview image of the business card are laid out.

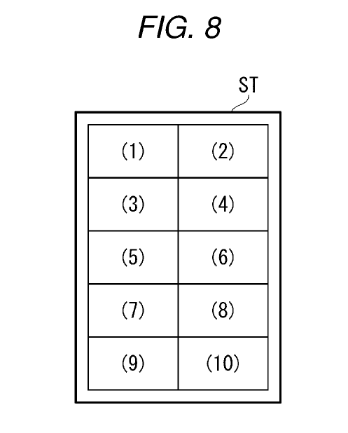

FIG. 8 is a view illustrating another example of the business card print. In the example illustrated in FIG. 8, the print engine 106 processes the information indicating the preview image of a business card, thereby, printing the image data in which the business card information displayed in the preview image of a business card is laid out in each of sections (1) to (10) of paper ST.

### Server

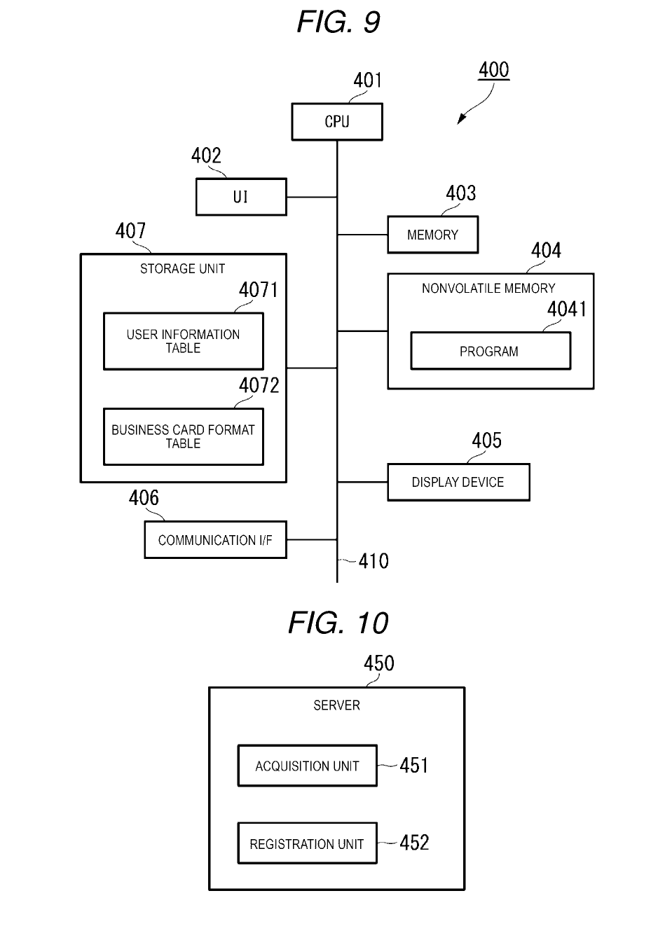

FIG. 9 illustrates an example of a hardware configuration of the server 400 according to the embodiment. The server 400 includes a CPU 401, a user interface (UI) 402, a memory 403, a nonvolatile memory 404, a display device 405, a communication I/F 406, and a storage unit 407.

For example, the CPU 401 executes a program stored in the nonvolatile memory 404, and controls each unit of the server 400 by using the memory 403 as a work memory.

The UI 402 is an input device that accepts an operation of a user. An example of the UI 402 includes a mouse, a pointing device such as a touch panel, a device for receiving character information such as a keyboard, a button, a touch sensor, a touch pad, and the like.

The memory 403 is configured by a RAM such as a volatile memory which uses a semiconductor element, and is used as a work memory of the CPU 401.

The nonvolatile memory 404 is configured by, for example, a hard disk (HD), a ROM, and the like. The nonvolatile memory 404 stores a program 4041 executed by the CPU 401.

The display device 405 is controlled by the CPU 401 and displays images, a graphical user interface (GUI), and the like. By executing the program 4041, the CPU 401 generates a control signal and a video signal representing an image to be displayed on the display device 405, and outputs the video signal to the display device 405. The display device 405 processes the video signal output by the CPU 401, thereby, displaying a video.

The communication I/F 406 is an interface for communicating with an external device such as the image forming apparatus 100 connected to a communication network such as the Internet. The communication I/F 406 transmits and receives various types of data such as a user information acquisition request, a user information acquisition response, a business card format acquisition request, a business card format acquisition response, and registration information. The communication I/F 406 outputs the user information acquisition request transmitted from the image forming apparatus 100 to the CPU 401. In addition, the communication I/F 406 transmits the user information acquisition response output from the CPU 401 to the image forming apparatus 100. The communication I/F 406 outputs the business card format acquisition information transmitted from the image forming apparatus 100 to the CPU 401. In addition, the communication I/F 406 transmits the business card format acquisition response output from the CPU 401 to the image forming apparatus 100. The communication I/F 406 outputs the registration information transmitted from the image forming apparatus 100 to the CPU 401.

The storage unit 407 is configured by, for example, a hard disk (HD), a ROM, and the like. The storage unit 407 stores a user information table 4071 and a business card format table 4072.

The user information table 4071 is information of a table format in which a user ID and user information of a user having the user ID are associated with each other. The user information includes a full name, an address, a telephone number, a mail address, a company name, a department name, user image information, and the like.

The business card format table 4072 is information of a table format in which business card type information that is information indicating a type of business card and business card format are associated with each other. The business card type information includes a single surface, double surfaces, a single surface with a photograph, double surfaces with photographs, and the like.

The internal bus 410 connects the CPU 401, the UI 402, the memory 403, the nonvolatile memory 404, the display device 405, the communication I/F 406, and the storage unit 407 to each other. Each unit connected to the internal bus 410 is capable of exchanging data with each other through the internal bus 410.

FIG. 10 is a functional block diagram illustrating an example of a functional configuration of the server according to the embodiment.

The server 400 according to the embodiment functions as a device including the acquisition unit 451 and the registration unit 452, as the CPU 401 executes the program 4041 stored in the nonvolatile memory 404.

All or a part of each function of the server 400 may be realized by using hardware such as an ASIC, a PLD, an FPGA, and the like. The program may be recorded in a computer-readable recording medium. The computer-readable recording medium is a portable medium such as a flexible disk, a magneto-optical disk, a ROM, and a CD-ROM, or is a storage device such as a hard disk embedded in a computer system. The server 400 may acquire a control program through an electric communication line.

The acquisition unit 451 acquires the user information acquisition request output from the communication I/F 406. The acquisition unit 451 acquires the user information stored in association with the user ID included in the acquired user information acquisition request from the user information table 4071 stored in the storage unit 407. The acquisition unit 451 creates a user information acquisition response including the acquired user information and the user ID, and outputs the created user information acquisition response to the communication I/F 406.

In addition, the acquisition unit 451 acquires business card format acquisition information output from the communication I/F 406. The acquisition unit 451 acquires the business card format stored in association with the business card type information included in the acquired business card format acquisition information from the business card format table 4072 stored in the storage unit 407. The acquisition unit 451 creates a business card format acquisition response including the acquired business card format and the user ID. The acquisition unit 451 outputs the created business card format acquisition response to the communication I/F 406.

In addition, the acquisition unit 451 acquires the registration information output from the communication I/F 406, and acquires the information indicating the image of a user included in the acquired registration information and the user ID. The acquisition unit 451 outputs the information indicating the acquired image of a user and the user ID to the registration unit 452.

The registration unit 452 acquires the information indicating the image of a user output from the acquisition unit 451 and the user ID. The registration unit 452 stores the image of a user in the user information table 4071 in association with the acquired user ID.

### Operation of Image Forming Apparatus

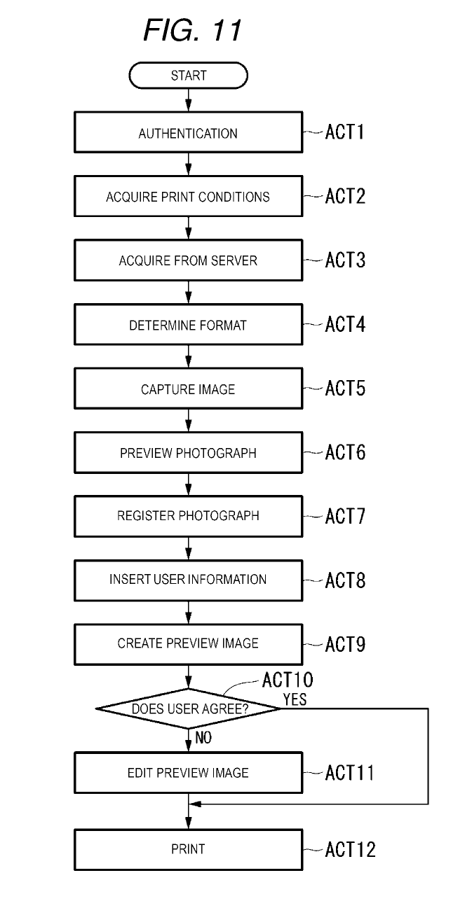

Processing of the image forming apparatus 100 according to the embodiment will be described with reference to FIG. 11. FIG. 11 is a flowchart illustrating an example of the processing of the image forming apparatus 100 according to the embodiment.

Act 1

A user touches a card to the control panel 120 of the image forming apparatus 100. The control panel 120 reads a user ID stored in an IC chip built in the card and outputs the read user ID to the information processing unit 101. The authentication unit 1011 authenticates by determining whether or not the user ID output from the control panel 120 is included in a user ID stored in the storage unit 105. The authentication unit 1011 outputs authentication results including information indicating that authentication is successful or information indicating that the authentication fails to the control panel 120, the acquisition unit 1012, and the creation unit 1013.

Act 2

The acquisition unit 1012 of the image forming apparatus 100 acquires the authentication results output from the authentication unit 1011. If the acquired authentication results include information indicating that the authentication is successful, the acquisition unit 1012 acquires information indicating business card print, business card type information, and business card number information which are output from the control panel 120. The acquisition unit 1012 outputs the information indicating the business card print, the business card type information, and the business card number information which are acquired to the creation unit 1013.

Act 3

The acquisition unit 1012 creates a business card format acquisition request which includes the business card type information and is addressed to the server 400. The acquisition unit 1012 outputs the created business card format acquisition request to the communication I/F 104. The acquisition unit 1012 acquires the business card format acquisition response, which is a response to the business card format acquisition request, through the communication I/F 104.

In addition, the acquisition unit 1012 acquires the user ID included in the authentication results, and creates a user information acquisition request which includes the acquired user ID and is addressed to the server 400. The acquisition unit 1012 outputs the created user information acquisition request to the communication I/F 104. The acquisition unit 1012 acquires a user information acquisition response that is a response to the user information acquisition request, and outputs the user information included in the acquired user information acquisition response to the creation unit 1013.

Act 4

The acquisition unit 1012 outputs the business card format included in the business card format acquisition response to the control panel 120. The control panel 120 displays the business card format output from the acquisition unit 1012 on the display 110. A user selects a business card format to be used from the business card format displayed on the display 110. As the user presses the business card format to be used on the display 110, information indicating the selected business card format is output to the information processing unit 101. The acquisition unit 1012 acquires information indicating the business card format. The acquisition unit 1012 outputs the information indicating the acquired business card format to the creation unit 1013. The creation unit 1013 acquires the information indicating the business card format acquired by the acquisition unit 1012, and sets the acquired business card format.

Act 5

If the business card type information includes information indicating presence of a photograph and the user information does not include the user image information, the acquisition unit 1012 outputs a start instruction to the image capturing device 150. The image capturing device 150 starts in accordance with the start instruction output from the acquisition unit 1012. The started image capturing device 150 captures an image of a user in accordance with an operation of the user.

Act 6

The image capturing device 150 displays a preview of the image of a user obtained by capturing an image. The user selects an image to be used from the image of the user which is previewed. The image capturing device 150 outputs the user image information selected by the user to the acquisition unit 1012. The acquisition unit 1012 outputs the user image information output from the image capturing device 150 to the creation unit 1013.

Act 7

The creation unit 1013 creates registration information including a user ID and image information output from the acquisition unit 1012. The creation unit 1013 outputs the created registration information to the communication I/F 104. The server 400 acquires the registration information output from the image forming apparatus 100 and registers the image information in the user information table 4071 in association with the user ID included in the acquired registration information.

Act 8

The creation unit 1013 inserts a company logo, a department name, a full name, a company name, a section name, an address, telephone/FAX which are included in the user information into the column 11 of a company logo, the column 12 of a department name, the column 13 of a full name, and the column 14 of a company name, a section name, an address, telephone/FAX of the business card format determined in ACT 4.

Act 9

The creation unit 1013 inserts the user image into the column 15 of a photograph of the business card format by processing the image information. Accordingly, the creation unit 1013 creates a business card preview image.

Act 10

The user selects whether to agree, edit, or return with reference to the business card preview image. If the user selects editing by pressing the edition button 17, the processing proceeds to ACT 11. If the user selects agreeing by pressing the OK button 16, the processing proceeds to ACT 12. If the user selects returning by pressing the return button 18, the processing proceeds to ACT 4 and the business card format selection image is displayed. Here, a case where the user selects editing and a case where the user selects agreeing will be continuously described. If the user presses the edition button 17, the creation unit 1013 outputs information indicating edition and image information to the edition unit 1014.

Act 11

The edition unit 1014 displays an image editing image on the display 110, based on the information indicating edition output from the creation unit 1013 and the image information. The user designates a print region by expanding the rectangular frame W displayed on the display 110 on the image of a user. When designating the region is completed, and subsequently, if clothes are changed, the user presses the change button 20, and if the clothes are not changed, the user presses the OK button 19. As the user presses the change button 20, the edition unit 1014 determines the region designated by the rectangular frame W as a print region, and displays an image for changing the clothes. In addition, as the user presses the OK button 19, the edition unit 1014 determines the region designated by the rectangular frame W as the print region.

As the user presses the OK button 19 after designating an upper body region of the image of a user, the image SI representing the suit is displayed. The user traces the display 110 while placing his or her finger on the image SI representing the suit, thereby, adjusting a position of the image SI representing the suit so as to match the image of a user. After the position of the image SI representing the suit is adjusted so as to match the image of a user, the user presses the OK button 19. If the user presses the OK button 19, the edition unit 1014 returns the image SI representing a semi-transparent suit to a real image which is an image to be actually printed from a semi-transparent image. The user presses the OK button 19 when agreeing to the image of the user.

If the user presses the OK button 19, the edition unit 1014 outputs the information representing the edited image of a user to the creation unit 1013. The creation unit 1013 displays the edited image of a user obtained by processing the information indicating the edited image of a user output from the edition unit 1014, in the column 15 of photographs. If the user agrees with the business card preview image, the user presses the OK button 16.

Act 12 If the user presses the OK button 16, the creation unit 1013 outputs information indicating the preview image of a business card to the storage unit 105. The storage unit 105 stores the information indicating the preview image of a business card output from the creation unit 1013. The user performs an operation of printing a business card. The print engine 106 performs printing by processing information indicating the preview image of a business card stored in the storage unit 105.

In the aforementioned embodiment, a case where the image forming apparatus 100 includes the image capturing device 150 is described, but embodiments are not limited to the example. For example, if the image forming apparatus 100 does not include the image capturing device 150, the user may capture an image of himself or herself by using an image capturing device owned by the user. The image information of a user may be transmitted from the image capturing device to the image forming apparatus 100, and the image forming apparatus 100 may create the preview image of a business card using the image information transmitted from the image capturing device.

In the aforementioned embodiment, a case where the image forming apparatus 100 stores the information indicating the preview image of a business card in the storage unit 105 is described, but exemplary embodiments are not limited to the example. For example, the image forming apparatus 100 may store the information indicating the preview image of a business card in an external storage unit connected to the image forming apparatus 100 such as a universal serial bus (USB) memory. In addition, the information may be output to the terminal device 300 connected to the network 50. In addition, the image forming apparatus 100 may print the preview image of a business card by processing the information indicating the preview image of a business card.

In the aforementioned embodiment, a case where a type of business card includes a single surface, double surfaces, a single surface with a photograph, double surfaces with photographs and the like is described, but exemplary embodiments are not limited to the example. For example, in a case of double surfaces, a single surface may be printed in Japanese, and a company guide, a map, a product introduction, and the like may be printed on a rear surface, and contents to be printed may be selected appropriately.

In the aforementioned embodiment, a case where, if a user selects a business card layout with a photograph among the presented business card layouts and the user information does not include the user image information, the image forming apparatus 100 starts the image capturing device 150 is described, but exemplary embodiments are not limited to the example. For example, even if the user selects the business card layout with a photograph among the presented business card layouts and the user information includes the user image information, if the user performs an operation of selecting that the user image information included in the user information is changed, the image forming apparatus 100 may start the image capturing device 150.

In the aforementioned embodiment, if authentication of a user is successful, the number of business cards that can be printed may be limited to a constant number.

The image forming apparatus 100 according to the present embodiment includes the authentication unit 1011, the acquisition unit 1012, the image capturing device 150, and the creation unit 1013. The authentication unit 1011 authenticates a user. The acquisition unit 1012 acquires user information of a user who is successfully authenticated by the authentication unit 1011 from the server 400 managing the user information. The image capturing device 150 captures an image of the user. The creation unit 1013 creates image information in which the image of a user obtained by capturing an image using the image capturing device 150 and the user information acquired by the acquisition unit 1012 are represented in a card. By providing this configuration, the image of a user captured by the image capturing device 150 on the spot can be used for a business card, and thus, it is possible to reduce complexity of work when the card is printed. In addition, a business card can be created by registering the latest user information in the server 400, based on latest information.

In addition, the creation unit 1013 creates a preview image in which an image of a user obtained by capturing an image using the image capturing device 150 and the user information acquired by the acquisition unit 1012 are represented on a card. The image forming apparatus 100 includes the edition unit 1014 which edits the image of a user included in the preview image created by the creation unit 1013. The creation unit 1013 creates image information in which the image of a user edited by the edition unit 1014 and the user information acquired by the acquisition unit 1012 are represented on a card. By providing this configuration, the preview image is created in which the image of a user captured by the image capturing device 150 and the user information acquired by the acquisition unit 1012 on the spot are represented on a card, and the image of a user included in the created preview image can be edited, and thus, it is possible to create a business card by using the edited image of a user.

In addition, the creation unit 1013 creates image information on a card, based on the image of a user and a format indicating the user information. The creation unit 1013 represents the image of a user obtained by capturing an image using the image capturing device 150 and the user information acquired by the acquisition unit 1012 on a card. By providing this configuration, it is possible to create a business card in accordance with a previously prepared business card format.

In addition, the creation unit 1013 creates image information in which the image of a user and the user information are represented on a card, based on a format selected by a user among a plurality of formats. By providing this configuration, it is possible to create a business card in accordance with a business card format selected by the user.

In addition, the edition unit 1014 edits clothes of a user included in an image. The creation unit 1013 creates image information in which the image of a user edited by the edition unit 1014, the clothing of a user, and the user information acquired by the acquisition unit 1012 are represented on a card. By providing this configuration, the clothes of a user included in the image of a user captured by the image capturing device 150 on the spot can be edited. Accordingly, it is possible to create a business card using the image of a user edited into clothes adapted to use of the business card.

In addition, the edition unit 1014 acquires a plurality of pieces of data on clothes from the server 400. The edition unit 1014 edits the clothes of a user included in an image, based on the data on clothes selected by the user among the plurality of pieces of acquired data on clothes. By providing this configuration, it is possible to create a business card from the plurality of pieces of data on clothes by using data on clothes selected by the user.

In addition, the display 110 is provided which displays a print preview image created by the creation unit 1013. By providing this configuration, the image forming apparatus 100 may cause a user to confirm a print preview image of a business card.

In addition, the registration unit 1015 is provided which registers image information of an image obtained by capturing an image by using the image capturing device 150 in the server 400. By providing this configuration, the image information of the image obtained by capturing an image by using the image capturing device 150 can be stored. Accordingly, it is possible to create a business card by using the stored image information without newly capturing an image if a business card is further required.

In addition, the print engine 106 is provided which prints an image obtained by processing image information created by the creation unit 1013 on a card. By providing this configuration, a business card can be printed. Here, if the image forming apparatus 100 has a color adjustment function and can cope with special paper, there is no need to prepare correction data and it is possible to easily print a necessary number of business cards using the special paper.

Each of the aforementioned devices has a computer therein. Processes of each processing of each device described above are stored in a computer-readable recording medium in the form of a program. The computer reads the program and executes the program, and thereby, the processing is performed. Here, the computer-readable recording medium includes a magnetic disk, a magneto-optical disk, a CD-ROM, a DVD-ROM, a semiconductor memory, and the like. In addition, the computer program may be transmitted to a computer through a communication line, and the computer receiving the program may execute the program. In addition, the program may be used for realizing a part of the aforementioned functions.

In addition, something that can realize the aforementioned functions by using a combination of programs previously recorded in the computer system, a so-called differential file (differential program) may be used.

While several embodiments are described, the embodiments are presented as examples and are not intended to limit the scope of the exemplary embodiment. The embodiments can be implemented in various other forms, and various omissions, substitutions, and changes can be performed without departing from the gist of the exemplary embodiment. The embodiments and modifications thereof are included in the scope and gist of the exemplary embodiment, and are also included in the exemplary embodiment described in the claims and the equivalent scope thereof.

In the aforementioned embodiments, the image capturing device 150 is an example of an image capturing unit, the business card is an example of a card, the display 110 is an example of a display unit, and the print engine 106 is an example of a print unit.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. An image forming apparatus comprising:
a processor that executes computer executable units, wherein the computer executable units comprise:
an authentication unit configured to authenticate a user; and
an acquisition unit configured to acquire user information of the user who is successfully authenticated by the authentication unit from a server which manages the user information; and
an image capturing unit configured as an image capturing device that receives a start instruction and captures an image of the user in response to a determination that the user information acquired from the server does not include user image information,
wherein the computer executable components further comprise:
a creation unit that creates image information in which the image of the user which is obtained by capturing the image using the image capturing unit and the user information which is acquired by the acquisition unit are represented on a card.

2. The apparatus according to claim 1,
wherein the creation unit creates a preview image in which the image of the user which is obtained by capturing an image using the image capturing unit and the user information which is acquired by the acquisition unit are represented on a card,
wherein the image forming apparatus further includes an edition unit that edits the image of the user which is included in the preview image that is created by the creation unit, and
wherein the creation unit creates image information in which the image of the user that is edited by the edition unit and the user information that is acquired by the acquisition unit are represented on a card.

3. The apparatus according to claim 1, wherein the creation unit creates the image information in which the image of the user that is obtained by capturing the image using the image capturing unit and the user information that is acquired by the acquisition unit are represented on a card, based on a format representing the image of the user and the user information on the card.

4. The apparatus according to claim 3, wherein the creation unit creates the image information in which the image of the user and the user information are represented on the card, based on the format selected by the user among a plurality of the formats.

5. The apparatus according to claim 2,
wherein the edition unit edits clothes of the user that is included in the image, and
wherein the creation unit creates image information in which the image of the user that is edited by the edition unit, the clothes of the user, and the user information that is acquired by the acquisition unit are represented on a card.

6. The apparatus according to claim 5, wherein the edition unit acquires a plurality of pieces of data on clothes from the server, and edits the clothes of the user that is included in the image, based on the data on clothes which is selected by the user among the plurality of pieces of data on clothes that is acquired.

7. The apparatus according to claim 1, further comprising:
a display unit configured to display the image in which the image of the user which is created by the creation unit and the user information are represented on a card.

8. The apparatus according to claim 1, further comprising:
a registration unit configured to register the image information of the image which is obtained by capturing the image using the image capturing unit, in the server.

9. The apparatus according to claim 1, further comprising:
a print unit configured to print the image which is obtained by processing the image information that is created by the creation unit, on the card.

10. A control method, comprising:
acquiring user information of a user who is successfully authenticated from a server that manages the user information;
capturing an image of the user via an image capturing device in response to a determination that the user information acquired from the server does not include user image information; and
creating image information in which the image of the user that is obtained by the capturing the image and the user information that is acquired are represented on a card.
